(19) United States
(12) Patent Application Publication
(10) Pub. No.: US 2025/0044583 A1
(43) Pub. Date: Feb. 6, 2025

(54) OPTICAL DEFLECTOR AND OPTICAL SCANNING DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: YUICHI TOYOTA, Nisshin-shi (JP); KOICHI OYAMA, Nisshin-shi (JP); CHIHIRO MORIGUCHI, Nisshin-shi (JP); KOHEI TOYAMA, Nisshin-shi (JP)

(21) Appl. No.: 18/673,535

(22) Filed: May 24, 2024

(30) Foreign Application Priority Data
Aug. 1, 2023 (JP) 2023-125594

(51) Int. Cl. G02B 26/12; G02B 26/08

(52) U.S. Cl. CPC G02B 26/125; G02B 26/0808; G02B 26/0816

(57) ABSTRACT

An optical deflector includes: a reflecting section driven to rotate or oscillate around a drive axis; and a diffraction section configured to diffract light reflected by the reflecting section. The reflecting section is driven to change a first incident angle of light, around the drive axis, incident on the diffraction section from the reflecting section. The diffraction section changes a first emission angle of light emitted from the diffraction section, around a first axis perpendicular to the drive axis and a predetermined direction defined to extend from the reflecting section toward the diffraction section perpendicularly to the drive axis. The diffraction section is driven about the drive axis together with the reflecting section to maintain a second incident angle of light incident on the diffraction section from the reflecting section, around the first axis.

### CROSS REFERENCE TO RELATED APPLICATION

This application is based on Japanese Patent Application No. 2023-125594 filed on Aug. 1, 2023, the disclosure of which is incorporated herein by reference.

### TECHNICAL FIELD

The present disclosure relates to an optical deflector and an optical scanning device.

### BACKGROUND

A LIDAR system includes a motor, a laser light source configured to generate an optical beam, and a deflector including plural facets. In the LIDAR system, a first facet of the plural facets has a facet normal direction. The deflector is coupled to the motor and configured to rotate about the rotation axis to deflect the optical beam from the laser light source. The LIDAR is an abbreviation for Light Detection and Ranging/Laser Imaging Detection and Ranging.

### SUMMARY

According to an aspect of the present disclosure, an optical deflector includes: a reflecting section that is driven by a power source to either rotate or oscillate around a drive axis to reflect light from a light source; and a diffraction section configured to diffract light reflected by the reflecting section to emit light at an angle in response to a wavelength of an incident light. The reflecting section is driven to change a first incident angle of light, about the drive axis, incident on the diffraction section from the reflecting section. When the wavelength of the incident light is changed, the diffraction section changes a first emission angle of light emitted from the diffraction section about a first axis perpendicular to the drive axis and a predetermined direction defined to extend from the reflecting section toward the diffraction section perpendicularly to the drive axis. A change in the first incident angle changes a second emission angle of light emitted from the diffraction section about the drive axis. The diffraction section is driven about the drive axis together with the reflecting section to maintain a second incident angle of light, about the first axis, incident on the diffraction section from the reflecting section.

### BRIEF DESCRIPTION OF DRAWINGS

FIG. 1 is a configuration diagram of an optical scanning device having an optical deflector according to a first embodiment.

FIG. 2 is a view seen in a direction II of FIG. 1.

FIG. 3 is a diagram showing a light source of an optical integrated circuit in the optical scanning device.

FIG. 4 is a diagram showing a waveguide of an optical integrated circuit in the optical scanning device.

FIG. 5 is a diagram showing a diffraction section of the optical deflector.

FIG. 6 is a diagram showing an operation of the optical scanning device.

FIG. 7 is a diagram showing the optical scanning device when a reflecting section of the optical deflector is rotated.

FIG. 8 is a diagram showing a pattern of reflection points when light from the diffraction section is applied to a plane.

FIG. 9 is a diagram showing a pattern of reflection points when light is applied to a plane by a deflector of a comparative example.

FIG. 10 is a diagram showing a modified optical deflector.

FIG. 11 is a diagram showing a modified optical deflector.

FIG. 12 is a diagram showing a diffraction section of an optical deflector of a modification.

FIG. 13 is a diagram showing a diffraction section of an optical deflector of a modification.

FIG. 14 is a diagram showing a light source of an optical integrated circuit in a modification of an optical scanning device.

FIG. 15 is a diagram for explaining an operation of a modified optical scanning device.

FIG. 16 is a diagram showing a waveguide and a mirror of an optical integrated circuit in a modified optical scanning device.

FIG. 17 is a diagram showing a waveguide and a mirror of an optical integrated circuit in a modified optical scanning device.

FIG. 18 is a diagram showing a waveguide and micro lens of an optical integrated circuit in a modified optical scanning device.

FIG. 19 is a cross-sectional view of an optical scanning device having an optical deflector according to a second embodiment.

FIG. 20 is a configuration diagram of an optical scanning device having an optical deflector according to a third embodiment.

FIG. 21 is a configuration diagram of an optical scanning device having an optical deflector according to a fourth embodiment.

FIG. 22 is a configuration diagram of an optical scanning device having an optical deflector according to a fifth embodiment.

FIG. 23 is a configuration diagram of an optical scanning device having an optical deflector according to a sixth embodiment.

FIG. 24 is a diagram showing an incident adjustment element of a modified optical deflector.

### DETAILED DESCRIPTION

A LIDAR system includes a motor, a laser light source configured to generate an optical beam, and a deflector including facets. In the LIDAR system, a first facet of the plural facets has a facet normal direction. The deflector is coupled to the motor to rotate about the rotation axis to deflect the optical beam from the laser light source. The LIDAR is an abbreviation for Light Detection and Ranging/Laser Imaging Detection and Ranging.

In the LIDAR system, as the deflector rotates, in addition to change in the angle of light reflected by the deflector around the rotation axis, there is also a change in the angle of light reflected by the deflector around a second axis perpendicular to the facet normal direction and the rotation axis. Thus, the angle of light reflected at the deflector changes about the second axis perpendicular to the facet normal direction and the rotation axis. For this reason, when a plane is irradiated with light from the deflector, the pattern shape of reflection points on the plane, which is formed as the deflector rotates, is distorted. Therefore, for example, in the LIDAR system, the accuracy of identifying the shape of an object is lowered when light from the deflector is applied to the object.

The present disclosure provides an optical deflector and an optical scanning device that suppress distortion in a pattern shape of reflection points of an object.

According to an aspect of the present disclosure, an optical deflector includes: a reflecting section that is driven by a power source to either rotate or oscillate around a drive axis to reflect light from a light source; and a diffraction section configured to diffract light reflected by the reflecting section to emit light at an angle in response to a wavelength of an incident light. The reflecting section is driven to change a first incident angle of light, about the drive axis, incident on the diffraction section from the reflecting section. When the wavelength of the incident light is changed, the diffraction section changes a first emission angle of light emitted from the diffraction section about a first axis perpendicular to the drive axis and a predetermined direction defined to extend from the reflecting section toward the diffraction section perpendicularly to the drive axis. A change in the first incident angle changes a second emission angle of light emitted from the diffraction section about the drive axis. The diffraction section is driven about the drive axis together with the reflecting section to maintain a second incident angle of light incident on the diffraction section from the reflecting section about the first axis.

According to another aspect of the present disclosure, an optical scanning device includes: a power source; a light source; an optical deflector; and a light receiving element. The optical deflector includes a reflecting section driven to rotate or oscillate about a drive axis by the power source to reflect light from the light source, and a diffraction section that diffracts light reflected by the reflecting section and emits light at an angle in response to a wavelength of an incident light. The light receiving element is configured to receive light emitted from the diffraction section and reflected by an object via the diffraction section and the reflecting section. The reflecting section is driven to change a first incident angle of light, about the drive axis, incident on the diffraction section from the reflecting section. When the wavelength of the incident light changes, the diffraction section changes a first emission angle of light emitted from the diffraction section about a first axis perpendicular to the drive axis and a predetermined direction defined to extend from the reflecting section toward the diffraction section perpendicularly to the drive axis. A change in the first incident angle changes a second emission angle of light emitted from the diffraction section about the drive axis. The diffraction section is driven about the drive axis together with the reflecting section to maintain a second incident angle of light incident on the diffraction section from the reflecting section about the first axis.

Thereby, even while the reflecting section is driven, the second incidence angle is maintained. Therefore, the first emission angle does not change while the reflecting section is driven. Thus, a distortion in the pattern shape defined by the reflection points of the object is suppressed.

Hereinafter, embodiments will be described with reference to the drawings. In the following embodiments, the same or equivalent portions are denoted by the same reference numerals, and the description thereof will be omitted.

### First Embodiment

An optical scanning device has an optical deflector to suppress a distortion in pattern shape of reflection points of an object. The optical scanning device is used, for example, in LIDAR.

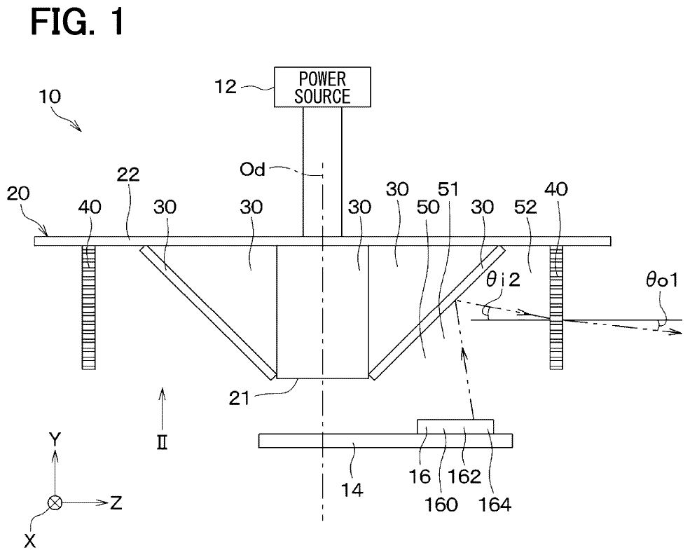

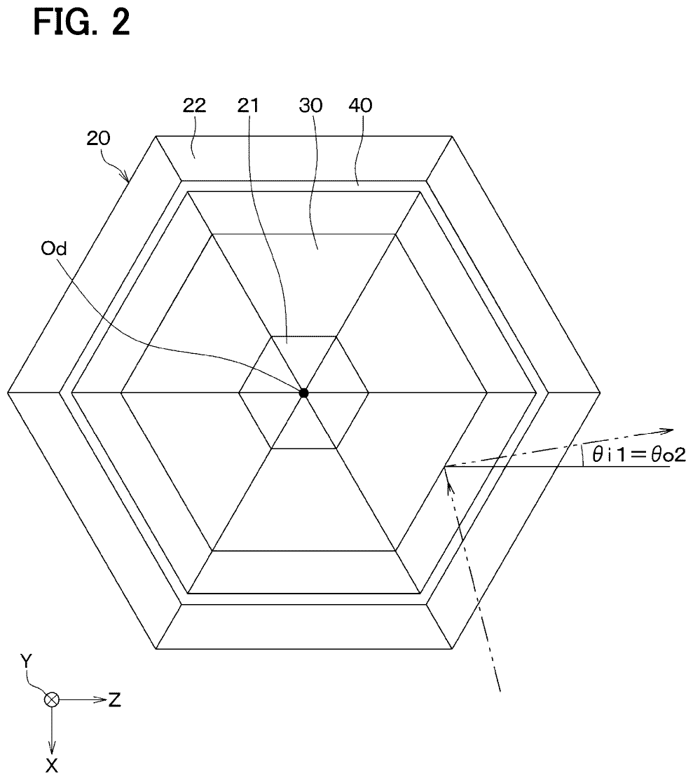

Specifically, as shown in FIGS. 1 and 2, the optical scanning device 10 includes a power source 12, a semiconductor substrate 14, an optical integrated circuit 16, and an optical deflector 20.

The power source 12 is a motor or the like, and drives a target object to rotate or oscillate around a drive axis Od.

The semiconductor substrate 14 is made of, for example, silicon. The optical integrated circuit 16 is formed on the semiconductor substrate 14. The optical integrated circuit 16 includes a light source 160, a waveguide 162, and a light receiving element 164.

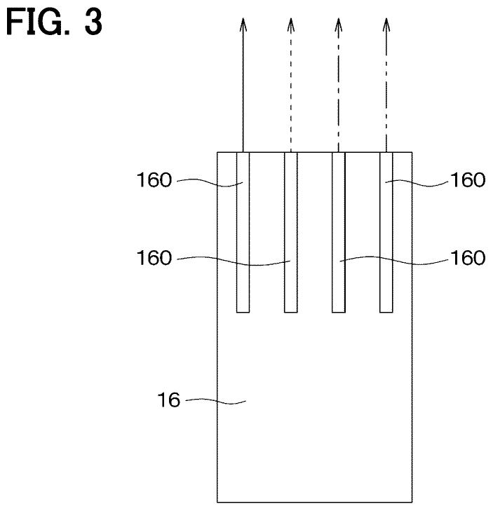

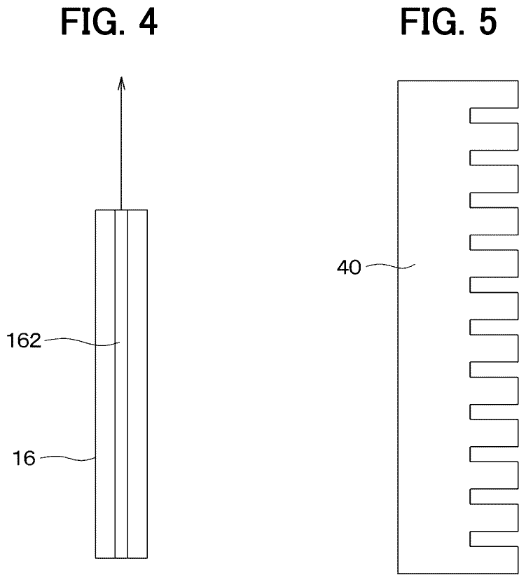

As shown in FIG. 3, plural light sources 160 are arranged. The light source 160 radiates light in different wavelength bands Δλ1, Δλ2, Δλ3, and Δλ4 used for optical communication such as S, C band, through the waveguide 162 shown in FIG. 4. In FIG. 3, light of Δλ1 is shown by a solid line. The light of Δλ2 is shown as a dashed line. The light of Δλ3 is shown by a single chain line. The light of Δλ4 is shown by a double chain line.

As shown in FIG. 1, the light receiving element 164 is a photodiode, a phototransistor, or the like, and receives light that is reflected by an object after irradiated from the light source 160 via the optical deflector 20.

The optical deflector 20 deflects the light from the light source 160 and irradiates the object with the deflected light. Specifically, the optical deflector 20 includes a first holding portion 21, a second holding portion 22, a reflecting section 30, a diffraction section 40, and a light transmitting unit 50.

The first holding portion 21 is made of metal, resin, or the like. As shown in FIGS. 1 and 2, the first holding portion 21 is formed, for example, in the shape of a regular hexagonal truncated pyramid. A hole (not shown) is formed in the first holding portion 21. A portion of the power source 12 is inserted into the hole of the first holding portion 21. Thereby, the first holding portion 21 is driven by the power source 12 about the drive axis Od.

The second holding portion 22 is made of metal, resin, or the like. The second holding portion 22 is formed, for example, in a regular hexagonal plate shape orthogonal to the drive axis Od. Further, the second holding portion 22 is connected to the first holding portion 21 in the axial direction of the drive axis Od. Therefore, the second holding portion 22 is driven by the power source 12 and the first holding portion 21 about the drive axis Od.

The reflecting section 30 is a mirror or the like, and reflects the light from the light source 160. The reflecting section 30 is formed on the side surface of the first holding portion 21 by vapor deposition or the like. Thereby, the reflecting section 30 is driven by the power source 12, the first holding portion 21, and the second holding portion 22 about the drive axis Od. The side surface of the reflecting section 30 is shaped in a truncated regular hexagonal pyramid.

As shown in FIG. 5, the diffraction section 40 is a diffraction grating in which a groove has a square shape. As shown in FIGS. 1 and 2, the external shape of the diffraction section 40 is a regular hexagonal prism extending in the drive axis Od. The diffraction section 40 is arranged outside the reflecting section 30 in the direction orthogonal to the drive axis Od. Further, the diffraction section 40 has a shape corresponding to the shape of the reflecting section 30, in this embodiment, such as a regular hexagonal shape. The diffraction section 40 diffracts the light reflected by the reflecting section 30. Thereby, the diffraction section 40 emits light at an angle corresponding to the wavelength of light incident on the diffraction section 40. Further, the diffraction section 40 is connected to the second holding portion 22 in the axial direction of the drive axis Od. Therefore, the diffraction section 40 is driven by the power source 12, the first holding portion 21, the second holding portion 22, and the reflecting section 30 about the drive axis Od.

The light transmitting unit 50 has a first transmission section 51 and a second transmission section 52. The first transmission section 51 is formed between the light source 160 and the reflecting section 30, and is defined as a space. The first transmission section 51 transmits light directed from the light source 160 toward the reflecting section 30. The second transmission section 52 is formed between the reflecting section 30 and the diffraction section 40, and is defined as a space. The second transmission section 52 transmits light directed from the reflecting section 30 toward the diffraction section 40.

The optical scanning device 10 having the optical deflector 20 of the first embodiment is configured as described above. Next, the operation of the optical scanning device 10 when used in LIDAR will be explained.

Here, in order to explain the operation of the optical scanning device 10, the following terms will be defined. As shown in FIGS. 1 and 2, a Cartesian coordinate system with the center of the optical deflector 20 as a reference is defined as a deflector coordinate system. The X axis, Y axis, and Z axis in the deflector coordinate system are orthogonal to each other. The deflector coordinate system is expressed as a right-handed system. The Y axis is parallel to the drive axis Od. The Z axis corresponds to a predetermined direction perpendicular to the drive axis Od, and is defined to extend from the reflecting section 30 toward the diffraction section 40. The X axis is a first axis perpendicular to the drive axis Od and the predetermined direction. As shown in FIG. 2, the incident angle of light that enters the diffraction section 40 from the reflecting section 30, around the drive axis Od or the Y axis, is defined as a first incident angle θi1. Around the X axis, as shown in FIG. 1, the incident angle of light that enters the diffraction section 40 from the reflecting section 30 is defined as a second incident angle θi2. The angle of light emitted from the diffraction section 40, around the X axis, is defined as a first emission angle θo1. As shown in FIG. 2, the angle of light emitted from the diffraction section 40 around the drive axis Od or the Y axis is defined as a second emission angle θo2. The first incident angle θi1, the second incident angle θi2, the first emission angle θo1, and the second emission angle θo2 are defined with respect to the Z axis. Further, the shape of the grating section of the diffraction section 40 is adjusted so that the first incident angle θi1 and the second emission angle θo2 are the same. In FIG. 1 and FIG. 2, the path of light is schematically shown by a double chain line.

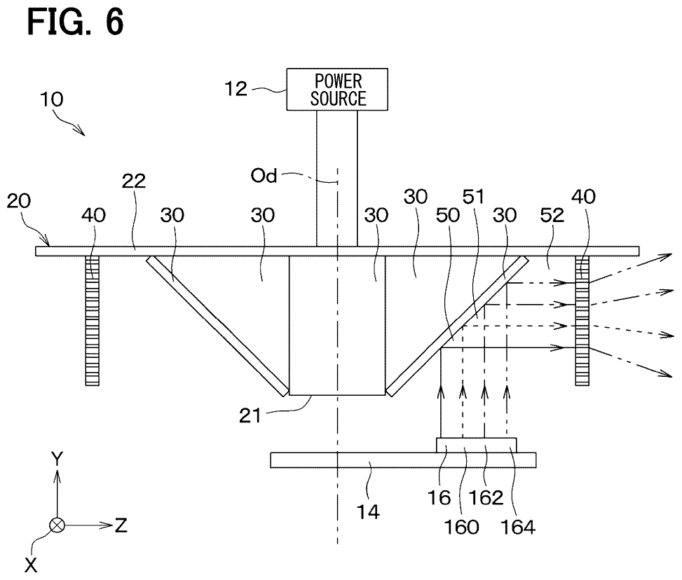

Then, as shown in FIG. 6, lights in plural wavelength bands are emitted from the light source 160. The light emitted from the light source 160 passes through the first transmission section 51 and is reflected at the reflecting section 30. The light reflected by the reflecting section 30 enters the diffraction section 40 via the second transmission section 52. The light incident on the diffraction section 40 is diffracted and exits from the diffraction section 40. In FIG. 6, each path of light having different wavelengths is schematically shown by a solid line, a broken line, a single chain line, and a double chain line.

Here, the interval between the grooves of the diffraction section 40 is defined as d. The wavelength of light incident on the diffraction section 40 is defined as λ. The refractive index of medium of the diffraction section 40 is defined as n. At this time, the first emission angle θo1 is expressed as follows.

$$d \times sin ( θ i 2 ) + d \times sin ( θ o 1 ) = \frac{λ}{n}$$

$$sin ( θ o 1 ) = \frac{λ}{d \times n} - sin ( θ i2 )$$

$$θ o 1 = arcsin \{ \frac{λ}{d \times n} - sin ( θ i 2 ) \}$$

For each wavelength of light emitted from the light source 160, light is emitted from the diffraction section 40 at a first emission angle θo1 corresponding to the wavelength of the light incident on the diffraction section 40. Therefore, the diffraction section 40 changes the first emission angle θo1 when the wavelength of the light incident on the diffraction section 40 from the reflecting section 30 changes.

The light emitted from the diffraction section 40 is reflected by an object (not shown). The light reflected by the object passes through the diffraction section 40, the second transmission section 52, the reflecting section 30, and the first transmission section 51, and is received by the light receiving element 164. A calculation device (not shown) calculates the relative distance, speed, and direction from the optical scanning device 10 to the object based on the intensity of light received by the light receiving element 164.

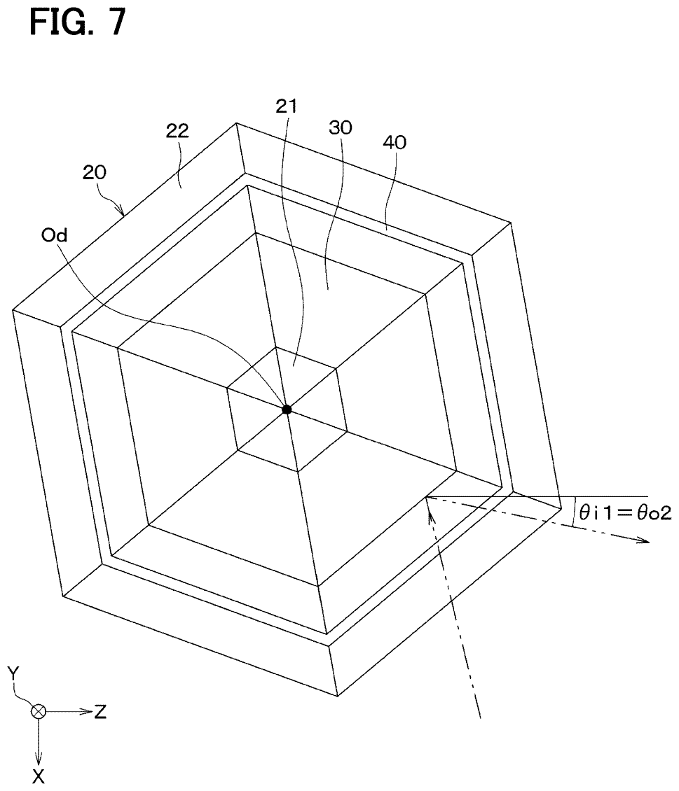

Further, as shown in FIG. 7, the reflecting section 30 is driven around the drive axis Od by the power source 12. Since the side surface shape of the reflecting section 30 is a truncated regular hexagonal pyramid, the hitting direction of light hitting on the reflecting section 30 changes. Therefore, the first incident angle θi1 changes, and the second emission angle θo2 changes. In FIG. 7, the path of light is schematically shown by a double chain line.

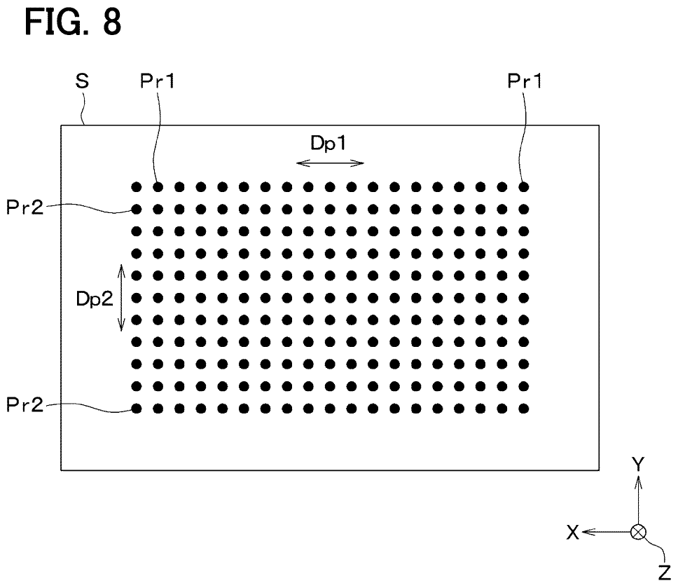

Further, at this time, the diffraction section 40 rotates together with the reflecting section 30 around the drive axis Od. Thereby, the diffraction section 40 maintains the second incident angle θi2. Therefore, the first emission angle θo1 is maintained. Thus, as shown in FIG. 8, when the light from the diffraction section 40 is applied to the plane S perpendicular to the Z axis, the pattern shape of the first reflection points Pr1 and the second reflection points Pr2 on the plane S is suppressed from distorting. The first reflection point Pr1 is a reflection point on the plane S, and changes as the reflecting section 30 rotates. The second reflection point Pr2 is a reflection point on the plane S, and changes depending on the wavelength of the light incident on the diffraction section 40.

The reflecting section 30 and the diffraction section 40 are adjusted in shape, positional relationship, and the like so that the first arrangement direction Dp1 in which the first reflection points Pr1 are arranged and the second arrangement direction Dp2 in which the second reflection points Pr2 are arranged are orthogonal to each other.

Further, as described above, the pattern shape of the reflection points of the object can be obtained from change in the rotation of the reflecting section 30 and the wavelength of light incident on the diffraction section 40. Therefore, the shape of the object is specified by the calculation device (not shown) from the intensity of the light received by the light receiving element 164, the first emission angle θo1, and the second emission angle θo2.

The optical scanning device 10 operates as described above. Next, a description will be given of how the optical scanning device 10 having the optical deflector 20 suppresses distortion in pattern shape of the reflection points of an object.

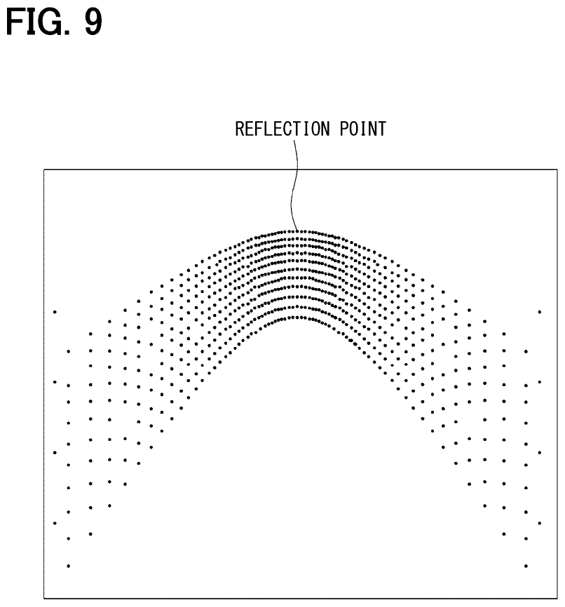

In a comparison example of LIDAR system, a deflector rotates. As a result, in addition to change in angle of light reflected by the deflector around the rotation axis, the angle of light reflected by the deflector also changes around another axis perpendicular to the rotation axis and the facet normal direction. This changes an angle of light emitted from the deflector around the axis perpendicular to the rotation axis and the facet normal direction. Therefore, when the light from the deflector is applied to a plane, as shown in FIG. 9, the pattern shape of the reflection points on the plane, which is formed as the deflector rotates, is distorted.

In contrast, in the optical scanning device 10 having the optical deflector 20 of this embodiment, the diffraction section 40 is driven along with the reflecting section 30 around the drive axis Od. Thereby, the diffraction section 40 maintains the second incident angle θi2 around the X axis.

Thereby, even while the reflecting section 30 is driven, the second incident angle θi2 is maintained. Therefore, the first emission angle θo1 does not change while the reflecting section 30 is driven. Therefore, as shown in FIG. 8, distortion in the pattern shape of the reflection points of the object is suppressed.

The optical scanning device 10 having the optical deflector 20 of the first embodiment has the following effects.
[1] The first arrangement direction Dp1 is orthogonal to the second arrangement direction Dp2. The first arrangement direction Dp1 is a direction in which the first reflection points Pr1 are arranged. The second arrangement direction Dp2 is a direction in which the second reflection points Pr2 are arranged.

This makes it easier to represent the pattern shape of the reflection points of the object in two dimensions. Therefore, the shape of the object can be more easily identified by the light emitted from the diffraction section 40, compared to a case where the first arrangement direction Dp1 and the second arrangement direction Dp2 are not perpendicular to each other.

### First Modification

In the first embodiment, the shape of the optical deflector 20 viewed in the drive axis Od is a regular hexagon, but the shape is not limited to this.

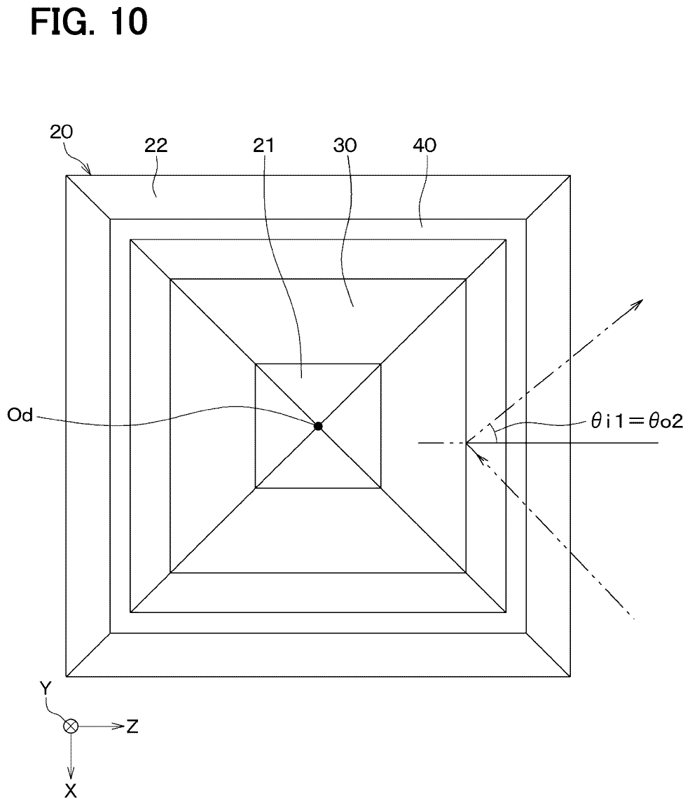

As shown in FIG. 10, the optical deflector 20 may have a square shape. Specifically, the first holding portion 21 is formed in a square truncated pyramid. The second holding portion 22 is formed into a square plate shape. The side surface shape of the reflecting section 30 is a truncated square pyramid. The outer shape of the diffraction section 40 is a square cylinder extending in the drive axis Od.

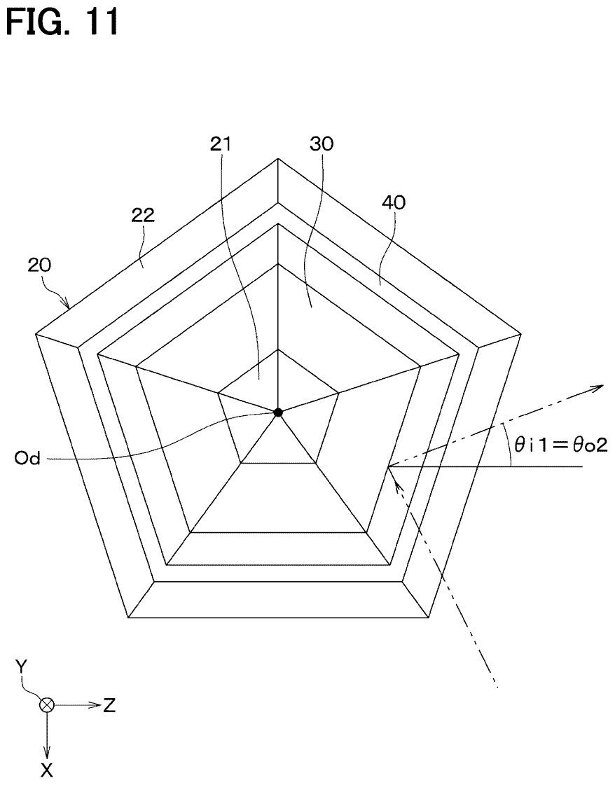

Further, as shown in FIG. 11, the shape of the optical deflector 20 may be a regular pentagon. Specifically, the first holding portion 21 is formed in a regular pentagonal truncated pyramid. The second holding portion 22 is formed in a regular pentagonal plate shape. The side surface shape of the reflecting section 30 is a truncated regular pentagonal pyramid. The outer shape of the diffraction section 40 is a regular pentagonal cylinder extending in the drive axis Od. Furthermore, the shape of the optical deflector 20 viewed in the drive axis Od may be polygonal, elliptical, or the like. Even with the above arrangement, the same effects as in the first embodiment can be achieved.

### Second Modification

In the first embodiment, the shape of the groove of the diffraction section 40 is a rectangular shape, but the shape is not limited to this.

As shown in FIG. 12, the groove of the diffraction section 40 has a sawtooth shape, and the diffraction section 40 may be a blazed diffraction grating.

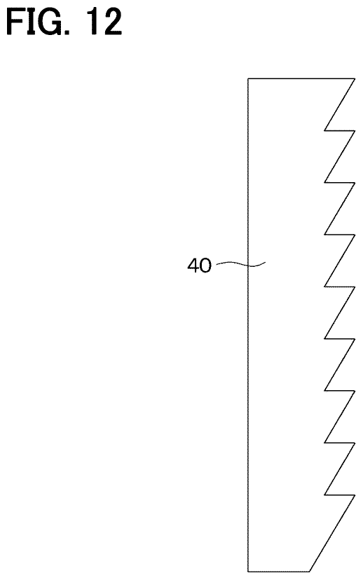

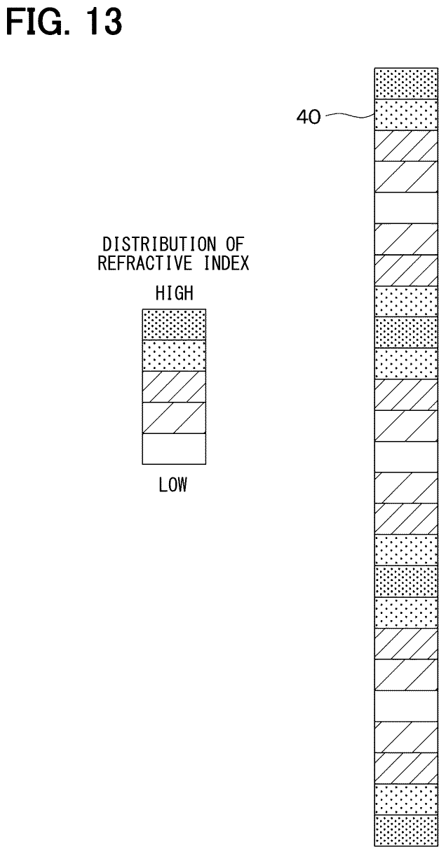

As shown in FIG. 13, the diffraction section 40 may be a VPH diffraction grating in which the refractive index of medium of the diffraction section 40 is modulated in a sinusoidal manner. VPH is an abbreviation for Volume Phase Holographic. Even with the above arrangement, the same effects as in the first embodiment can be achieved.

### Third Modification

In the first embodiment, plural light sources 160 are arranged, and each light source 160 emits light of a respective wavelength.

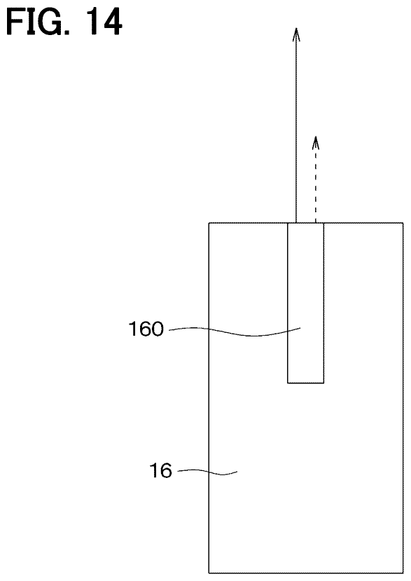

As shown in FIG. 14, the number of light sources 160 may be one. In this case, the light source 160 emits light of a single wavelength, and then emits light of a single wavelength different from the previous one. In FIG. 14, the light emitted first by the light source 160 is schematically shown by a solid line. The light subsequently emitted by the light source 160 is shown schematically in a dashed line.

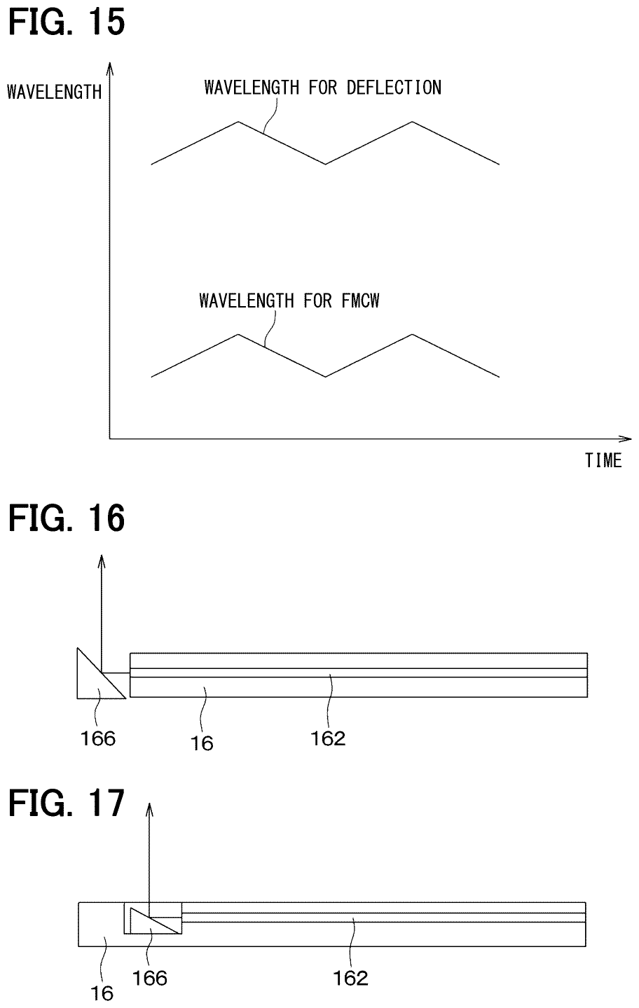

As shown in FIG. 15, at least one of the light sources 160 may be used for FMCW. FMCW is an abbreviation for Frequency Modulated Continuous Wave. Furthermore, each of the light sources 160 may change wavelength in different wavelength bands. Even with the above arrangement, the same effects as in the first embodiment can be achieved.

### Fourth Modification

In the first embodiment, the light source 160 emits light through the waveguide 162.

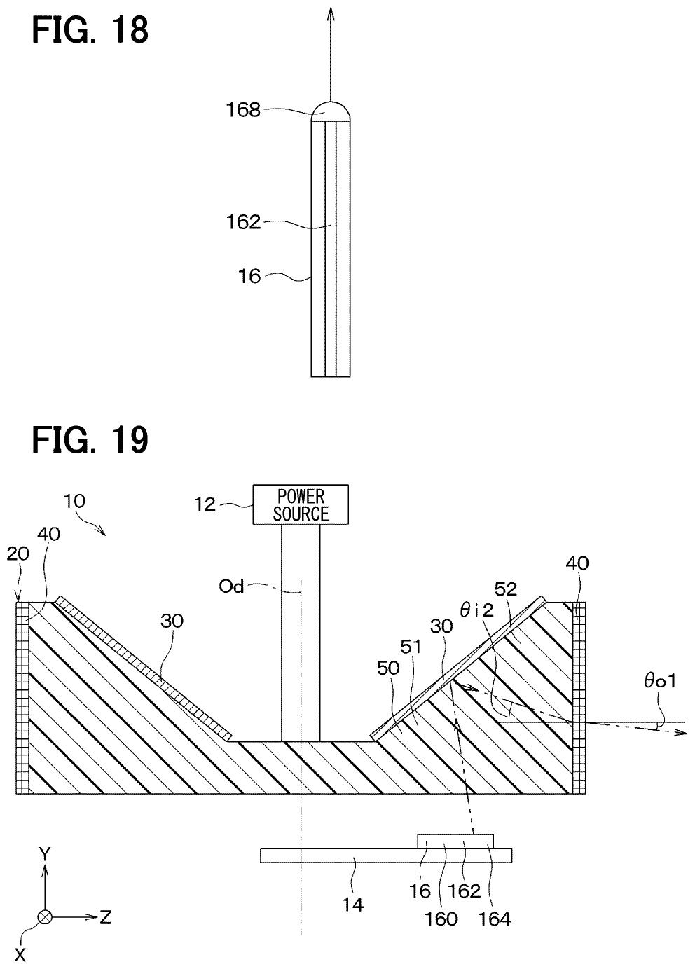

As shown in FIG. 16, the light source 160 may emit light via a waveguide 162 and a light source mirror 166 facing the waveguide 162. As shown in FIG. 17, the light source 160 may emit light via a waveguide 162 and a light source mirror 166 embedded in the optical integrated circuit 16. As shown in FIG. 18, the light source 160 may emit light through the waveguide 162 and a micro lens 168. Even with the above arrangement, the same effects as in the first embodiment can be achieved.

### Second Embodiment

In the second embodiment, the form of the optical deflector 20 is different from the first embodiment. The other configurations are the same as those of the first embodiment.

Specifically, as shown in FIG. 19, the optical deflector 20 does not have the first holding portion 21 and the second holding portion 22. Further, the light transmitting unit 50 is formed of a resin or the like that transmits light. Furthermore, the reflecting section 30, the diffraction section 40, and the light transmitting unit 50 are integrated.

The optical scanning device 10 having the optical deflector 20 of the second embodiment is configured in this way. The second embodiment achieves effects similar to the effects achieved by the first embodiment. The second embodiment also achieves the following effects.
[2] The reflecting section 30, the diffraction section 40, and the light transmitting unit 50 are integrated. Thereby, the light transmitting unit 50, the reflecting section 30, and the diffraction section 40 can be integrally molded. Therefore, the optical deflector 20 can be manufactured more easily than when the optical deflector 20 has the first holding portion 21 and the second holding portion 22.

### Third Embodiment

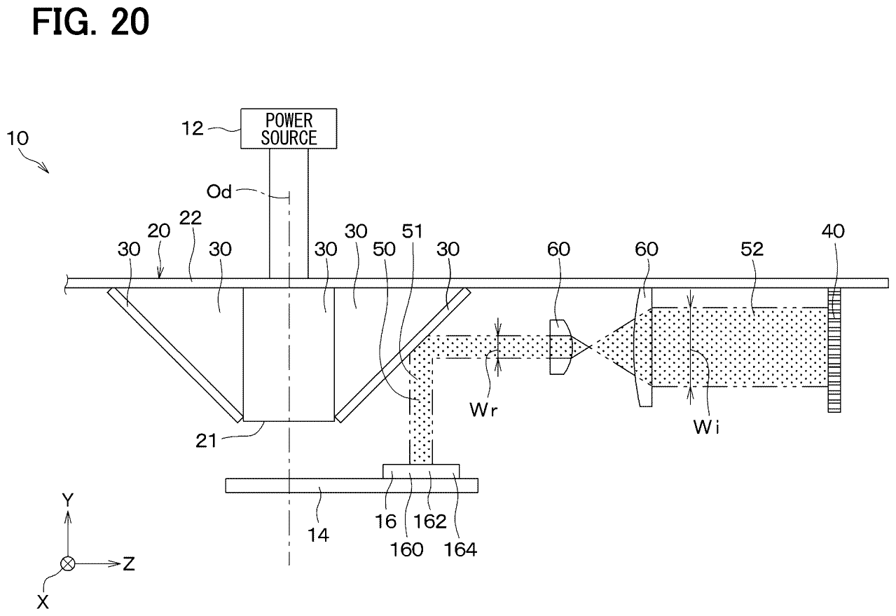

In the third embodiment, as shown in FIG. 20, the optical deflector 20 further includes a beam adjustment element 60. The other configurations are the same as those of the first embodiment.

The beam adjustment element 60 is arranged between reflecting section 30 and the diffraction section 40. The beam adjustment element 60 has plural lenses, thereby making the diffraction section incident beam diameter Wi larger than the reflected beam diameter Wr. In FIG. 20, light from the light source 160 is schematically shown with a dot pattern and a double chain line. Further, the diffraction section incident beam diameter Wi is the beam diameter of light incident on the diffraction section 40. The reflected beam diameter Wr is the beam diameter of the light reflected by the reflecting section 30. The beam diameter is defined along a particular line perpendicular to and intersecting the beam axis. The beam diameter is measured using D40, knife edge, Gaussian beam, FWHM, D86, and the like. FWHM is an abbreviation for Full Width at Half Maximum.

In this way, the optical scanning device 10 having the optical deflector 20 of the third embodiment is configured. The third embodiment achieves effects similar to the effects achieved by the first embodiment. The third embodiment also achieves the following effects.
[3] The optical deflector 20 further includes the beam adjustment element 60 that makes the diffraction section incident beam diameter Wi larger than the reflected beam diameter Wr.

This makes it easier for the light reflected by the reflecting section 30 to enter the diffraction section 40. Therefore, the range of light emitted from the diffraction section 40 is expanded. Therefore, the light emitted from the diffraction section 40 is more likely to be reflected by the object. Therefore, the intensity of the light reflected by the object increases. This makes it easier for the light receiving element 164 to receive the light reflected by the object via the diffraction section 40 and the reflecting section 30.

### Fourth Embodiment

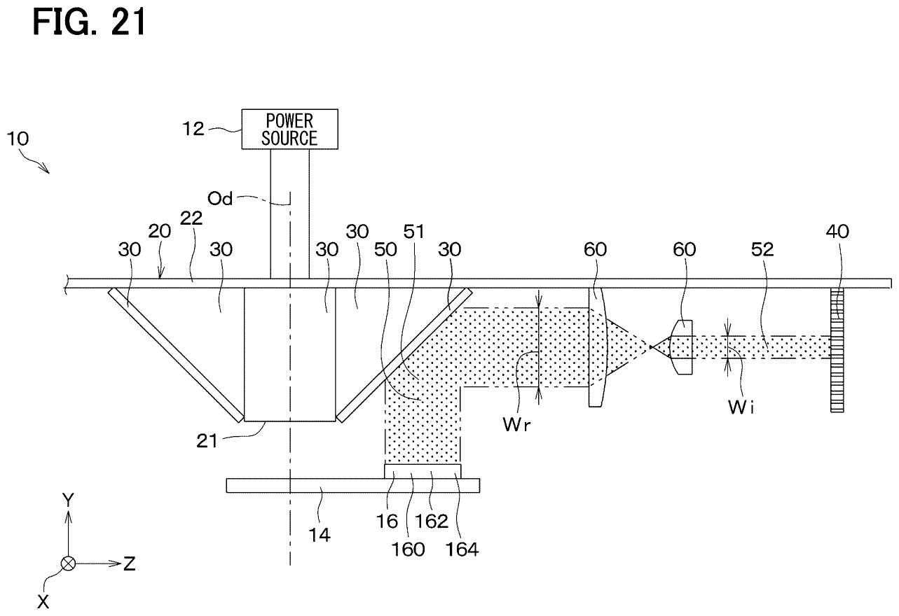

In the fourth embodiment, as shown in FIG. 21, the function of the beam adjustment element 60 is different from that in the third embodiment. The other configuration is the same as that of the third embodiment.

The beam adjustment element 60 makes the diffraction section incident beam diameter Wi smaller than the reflected beam diameter Wr instead of making the diffraction section incident beam diameter Wi larger than the reflected beam diameter Wr. In FIG. 21, light from the light source 160 is schematically shown with a dot pattern and a double chain line.

In this way, the optical scanning device 10 having the optical deflector 20 of the fourth embodiment is configured. This fourth embodiment also provides the same effects as the first embodiment. Furthermore, the fourth embodiment provides the effects described below.
[4] The optical deflector 20 includes the beam adjustment element 60 that makes the diffraction section incident beam diameter Wi smaller than the reflected beam diameter Wr.

Thereby, the beam diameter of the light emitted from the diffraction section 40 becomes relatively small. Therefore, the resolution regarding the object detection using the light emitted from the diffraction section 40 is increased.

### Fifth Embodiment

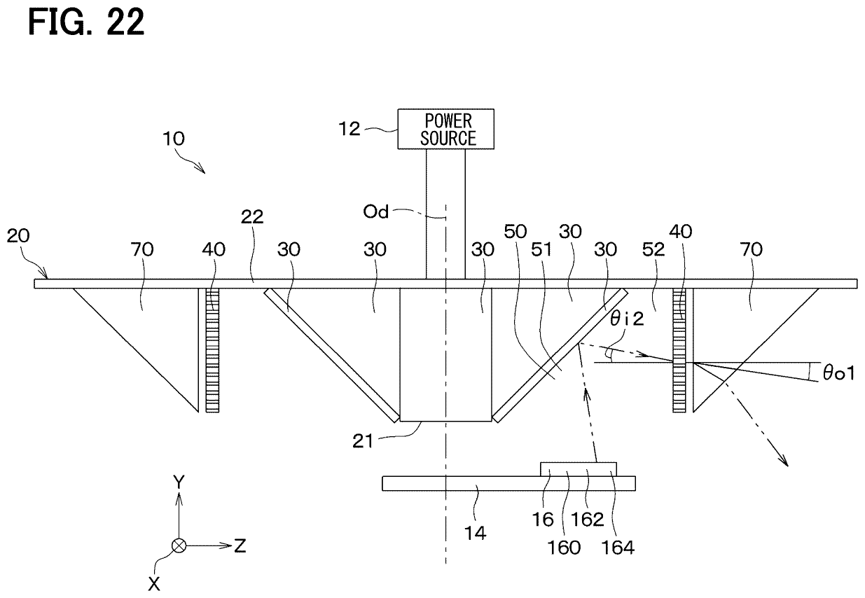

In the fifth embodiment, as shown in FIG. 22, the optical deflector 20 further includes an emission adjustment element 70. The other configurations are the same as those of the first embodiment.

The emission adjustment element 70 is arranged outside the diffraction section 40 in the direction orthogonal to the drive axis Od. The emission adjustment element 70 includes a prism or the like, so that the light emitted from the diffraction section 40 is emitted at an emission angle different from the first emission angle θo1.

In this way, the optical scanning device 10 having the optical deflector 20 of the fifth embodiment is configured. This fifth embodiment also achieves the same effects as the first embodiment. The fifth embodiment also achieves the following effects.
[5] The optical deflector 20 includes the emission adjustment element 70 that outputs the light emitted from the diffraction section 40 at an emission angle different from the first emission angle θo1.

Thereby, the first emission angle θo1 is adjusted. Therefore, the scanning position by the optical scanning device 10 can be adjusted.

### Sixth Embodiment

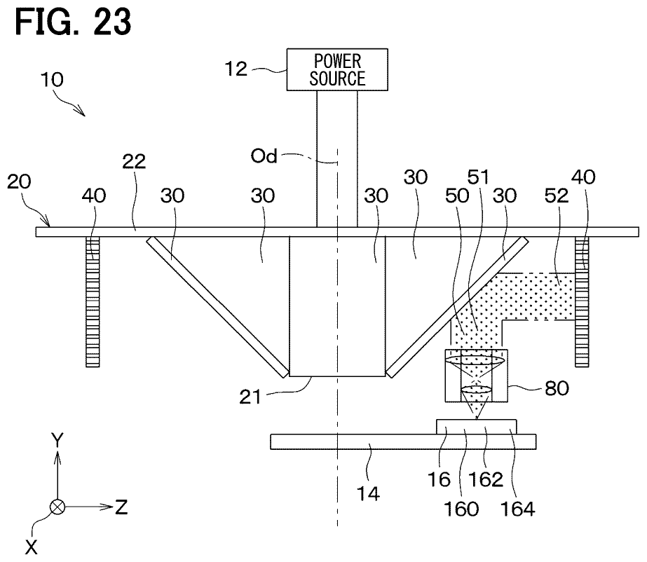

In the sixth embodiment, as shown in FIG. 23, the optical deflector 20 further includes an incidence adjustment element 80. The other configurations are the same as those of the first embodiment.

The incidence adjustment element 80 is arranged between the light source 160 and the reflecting section 30. The incidence adjustment element 80 has plural collimator lenses, so that the light from the light source 160 is collimated. In FIG. 23, light from the light source 160 is schematically shown with a dot pattern and a double chain line. Furthermore, collimated light is in parallel state with all rays within the beam. Further, it is assumed that parallelism in collimated light includes a manufacturing error range.

In this way, the optical scanning device 10 having the optical deflector 20 of the sixth embodiment is configured. This sixth embodiment also achieves the same effects as the first embodiment. The sixth embodiment also achieves the following effects.
[6] The optical deflector 20 further includes an incidence adjustment element 80 that converts the light from the light source 160 into collimated light.

Thereby, the light emitted from the diffraction section 40 also becomes collimated light. Therefore, compared to a case where the light emitted from the diffraction section 40 spreads radially, the light emitted from the diffraction section 40 is restricted from spreading or converging. Therefore, the light emitted from the diffraction section 40 can easily reach a long distance.

### Modifications

In the sixth embodiment, the incidence adjustment element 80 has plural collimator lenses to collimate the light from the light source 160, but is not limited thereto.

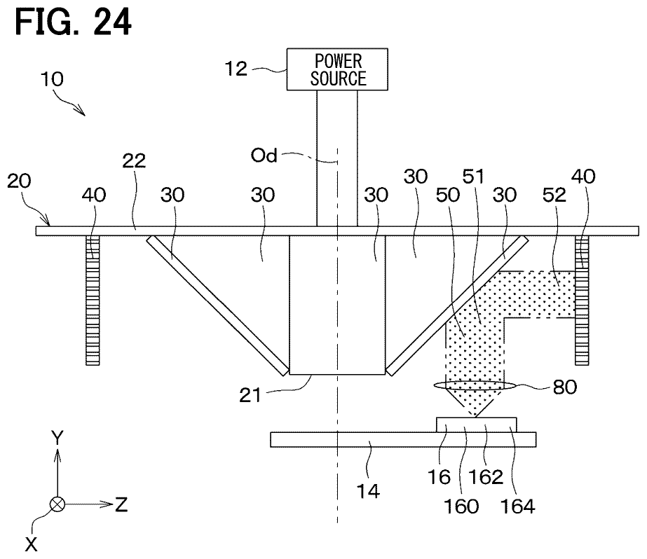

As shown in FIG. 24, the incidence adjustment element 80 may have a single lens or the like to collimate the light from the light source 160. In FIG. 24, the light from the light source 160 is schematically shown with a dot pattern and a double chain line.

### Other Embodiments

The present disclosure is not limited to the above-described embodiments, and the above embodiment can be appropriately modified. Individual elements or features of a particular embodiment are not necessarily essential unless it is specifically stated that the elements or the features are essential in the foregoing description, or unless the elements or the features are obviously essential in principle.

The above embodiments and modifications may be combined as appropriate.

What is claimed is:

1. An optical deflector comprising:
a reflecting section to be driven by a power source to rotate or oscillate around a drive axis to reflect light from a light source; and
a diffraction section configured to diffract light reflected by the reflecting section to emit light at an angle in response to a wavelength of an incident light, wherein
the reflecting section is driven to change a first incident angle of light, around the drive axis, incident on the diffraction section from the reflecting section,
when the wavelength of the incident light is changed, the diffraction section changes a first emission angle of light emitted from the diffraction section, around a first axis perpendicular to the drive axis and a predetermined direction defined to extend from the reflecting section toward the diffraction section perpendicularly to the drive axis,
a change in the first incident angle changes a second emission angle of light emitted from the diffraction section around the drive axis, and
the diffraction section is driven about the drive axis together with the reflecting section to maintain a second incident angle of light, around the first axis, incident on the diffraction section from the reflecting section.

2. The optical deflector according to claim 1, further comprising:
a light transmitting unit having a first transmission section formed between the light source and the reflecting section to transmit light from the light source toward the reflecting section; and a second transmission section formed between the reflecting section and the diffraction section to transmit light from the reflecting section toward the diffraction section, wherein
the reflecting section, the diffraction section, and the light transmitting unit are integrally formed with each other.

3. The optical deflector according to claim 1, further comprising a beam adjustment element to make a beam diameter of light incident on the diffraction section larger than a beam diameter of light reflected by the reflecting section.

4. The optical deflector according to claim 1, further comprising a beam adjustment element to make a beam diameter of light incident on the diffraction section smaller than a beam diameter of light reflected by the reflecting section.

5. The optical deflector according to claim 1, further comprising an emission adjustment element to output light emitted from the diffraction section at an emission angle different from the first emission angle.

6. The optical deflector according to claim 1, further comprising an incidence adjustment element to collimate light from the light source.

7. The optical deflector according to claim 1, wherein
when a light from the diffraction section is applied to a plane orthogonal to the predetermined direction, an arrangement direction in which first reflection points are arranged on the plane, which is changed by a driving of the reflecting section, is perpendicular to an arrangement direction in which second reflection points are arranged on the plane, which is changed by the wavelength of the incident light on the diffraction section.

8. An optical scanning device comprising:
a power source;
a light source;
an optical deflector including a reflecting section driven to rotate or oscillate about a drive axis by the power source to reflect light from the light source, and a diffraction section configured to diffract light reflected by the reflecting section and emit light at an angle in response to a wavelength of an incident light; and
a light receiving element configured to receive light emitted from the diffraction section and reflected by an object via the diffraction section and the reflecting section, wherein
the reflecting section is driven to change a first incident angle of light, around the drive axis, incident on the diffraction section from the reflecting section,
when the wavelength of the incident light is changed, the diffraction section changes a first emission angle of light emitted from the diffraction section around a first axis perpendicular to the drive axis and a predetermined direction defined to extend from the reflecting section toward the diffraction section perpendicularly to the drive axis,
a change in the first incident angle changes a second emission angle of light emitted from the diffraction section around the drive axis, and
the diffraction section is driven about the drive axis together with the reflecting section to maintain a second incident angle of light, around the first axis, incident on the diffraction section from the reflecting section.
